(19) United States
(12) Patent Application Publication
(10) Pub. No.: US 2015/0287102 A1
(43) Pub. Date: Oct. 8, 2015

(54) SYSTEMS AND METHODS FOR PROVIDING ADVERTISING SERVICES TO DEVICES BY ACCESSING ONE OR MORE AD DATABASES INCLUDING THIRD PARTY AD DATABASES USING AD SERVING TAGS

(71) Applicants: Arvind Gupta, San Carlos, CA (US); Wayne Chan, Millbrae, CA (US); Raymond Myers, Foster City, CA (US); Ben Reiter, San Francisco, CA (US); Rolando Abarca, San Francisco, CA (US)

(72) Inventors: Arvind Gupta, San Carlos, CA (US); Wayne Chan, Millbrae, CA (US); Raymond Myers, Foster City, CA (US); Ben Reiter, San Francisco, CA (US); Rolando Abarca, San Francisco, CA (US)

(73) Assignee: VUNGLE, INC., San Francisco, CA (US)

(21) Appl. No.: 14/260,148

(22) Filed: Apr. 23, 2014

Related U.S. Application Data
(60) Provisional application No. 61/974,975, filed on Apr. 3, 2014.

(51) Int. Cl. G06Q 30/02

(52) U.S. Cl. CPC G06Q 30/0277

(57) ABSTRACT

Methods and systems are described for providing advertising services for devices by accessing one or more ad databases including third party ad databases using ad serving tags. In one embodiment, a system includes a storage medium to store one or more software programs and processing logic that is configured to execute instructions of at least one software program to receive an advertising request from a device upon the device having an ad play event for an initiated software application, send an ad call or request to an ad store having ad campaigns and ads, and receive an ad response from the ad store in response to the ad call or request. The ad response includes a payload with one or more ads or potential ad campaigns for being streamed to the device or an ad serving tag for accessing one or more third party ad databases.

### RELATED APPLICATIONS

This application claims the benefit of U.S. Provisional Application No. 61/974,975, filed on Apr. 3, 2014, the entire contents of which are hereby incorporated by reference.

This application is related to application Ser. No. ______, filed Apr. 23, 2014, entitled: SYSTEMS AND METHODS FOR PROVIDING ADVERTISING SERVICES TO DEVICES and application Ser. No. ______, filed Apr. 23, 2014, entitled SYSTEMS AND METHODS FOR PROVIDING ADVERTISING SERVICES TO DEVICES BASED ON AT LEAST ONE CONFIGURABLE PARAMETER INCLUDING AT LEAST PARTIALLY BASED ON A CACHE WINDOW.

### FIELD OF THE INVENTION

Embodiments of the invention are generally related to systems and methods for providing advertising services to devices by accessing one or more ad databases including one or more ad databases including third party ad databases using ad serving tags.

### BACKGROUND

Mobile advertising is a form of advertising via mobile (wireless) phones or other mobile devices. Advertisements (ads) can be presented to the intended user in the form of banner ads, text boxes, and video ads. However, these ads may be difficult to distribute to a targeted user in a timely manner and the user may not be responsive and interested in the ads.

### SUMMARY

Methods and systems are described for providing advertising services for devices by accessing one or more ad databases including third party ad databases using ad serving tags. In one embodiment, a system includes a storage medium to store one or more software programs and processing logic that is configured to execute instructions of at least one software program to receive an advertising request from a device upon the device having an ad play event for an initiated software application, send an ad call or request to an ad store having ad campaigns and ads and receive an ad response from the ad store in response to the ad call or request. The ad response includes a payload with one or more ads or potential ad campaigns for being streamed to the device or an ad serving tag for accessing one or more third party ad databases.

Other embodiments are also described. Other features of embodiments of the present invention will be apparent from the accompanying drawings and from the detailed description which follows.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 shows an embodiment of a block diagram of a system for providing advertising services.

FIG. 2 illustrates a flow diagram of operations for providing advertising services including ad campaigns that are located on a device or streamed to a device in accordance with certain embodiments.

FIG. 3 illustrates a flow diagram of operations for a method of providing advertising services including ad campaigns that are located on a device or streamed to a device in accordance with certain embodiments.

FIG. 4 illustrates a flow diagram of operations for a method of providing advertising services including ad campaigns that are located on a device or streamed to a device from an ad system having access to first and third party ad databases in accordance with certain embodiments.

FIG. 5 illustrates a flow diagram of operations for a method of providing advertising services including ad campaigns that are located on a device or streamed from an ad system having access to first and third party ad databases in accordance with certain embodiments.

FIG. 6 illustrates a flow diagram of operations for a method of providing advertising services including processing ad serving tags in accordance with certain embodiments.

FIG. 7 illustrates a flow diagram of operations for a method of providing advertising services including processing ad serving tags in accordance with certain embodiments.

FIG. 8 illustrates a diagrammatic representation of a machine in the exemplary form of a device 800 within which a set of instructions, for causing the machine to perform any one or more of the methodologies discussed herein, may be executed in accordance with certain embodiments.

### DETAILED DESCRIPTION

Methods and systems are described for providing advertising services to devices by accessing one or more ad databases including third party ad databases using ad serving tags. In one embodiment, a system having an ad server receives an advertising request from a device upon the device having an ad play event for an initiated software application, sends an ad call or request to an ad store having ad campaigns and ads, and receives an ad response from the ad store in response to the ad call or request. The ad response includes a payload with one or more ads or ad campaigns for being streamed to the device or an ad serving tag for accessing one or more third party ad databases.

The system is designed to deliver the most relevant and highest converting ads to devices using data about device behavior and configurable parameters. The system can deliver ads from an ad store within the system or from a third party ad database using third party ad serving tags.

In mobile video advertising, high performing campaigns are needed for advertisers, publishers, and users of the publishers. Advertisers include organizations that pay for advertising services including ads on a publisher network of applications and games. Publishers provide content for users. Publishers can include developers of mobile applications and games. The publishers are interested in generating revenue through displaying video ads to their users.

Performance can be defined in terms of click-through rates (CTR), conversion rates, and video completion rates. The process in which a user selects an ad is referred to as a click-through, which is intended to encompass any user selection. The ratio of a number of click-throughs to a number of times an ad is displayed is referred to as the CTR of the ad. A conversion occurs when a user performs a transaction related to a previously viewed ad. For example, a conversion may occur when a user views a video ad and installs an application being promoted in the video ad. A conversion may occur when a user views a video ad and installs an application being promoted in the video ad within a certain time period. A conversion may occur when a user is shown an ad and decides to make a purchase on the advertiser's web site within a certain time period. The ratio of the number of conversions to the number of times an ad is displayed is referred to as the conversion rate. A video completion rate is a ratio of a number of video ads that are displayed to completion to a number of video ads initiated on a device. Advertisers may also pay for their ads through an advertising system in which the advertiser bid on ad placement on a cost-per-click (CPC) or a cost-per-mille (CPM) basis with a mille representing a thousand impressions.

In this section several embodiments of this invention are explained with reference to the appended drawings. Whenever the shapes, relative positions and other aspects of the parts described in the embodiments are not clearly defined, the scope of the invention is not limited only to the parts shown, which are meant merely for the purpose of illustration.

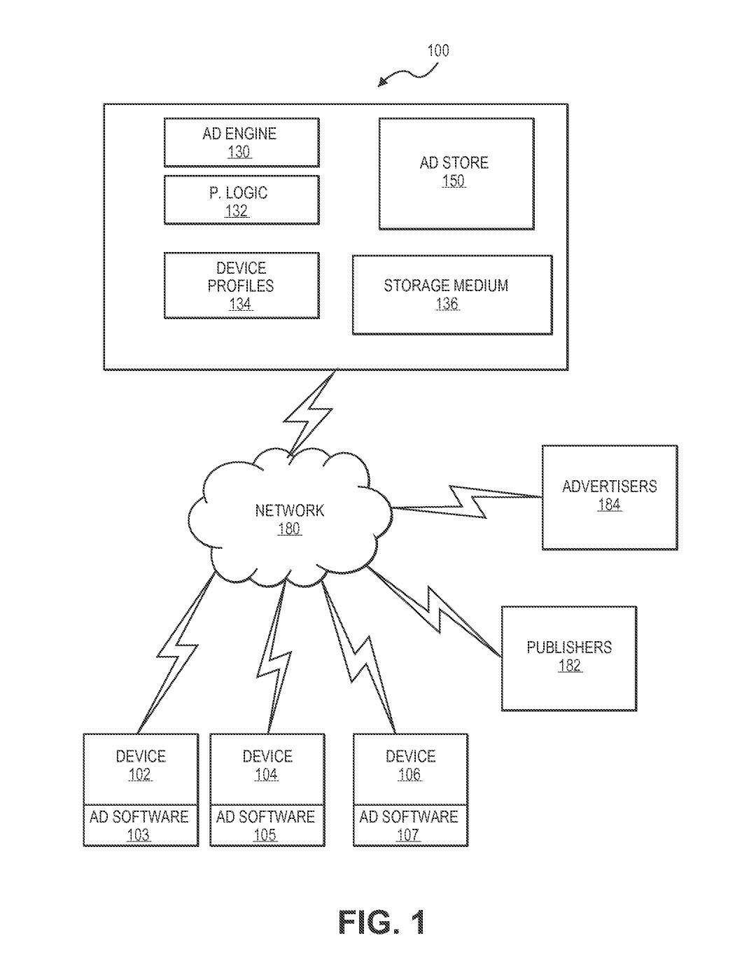

FIG. 1 shows an embodiment of a block diagram of a system 100 for providing advertising services. The system 100 includes an advertising engine 130, processing logic 132, device profiles 134, a storage medium 136, and an ad store 150. The system 100 provides advertising services for advertisers 184 to devices 102, 104, and 106 (e.g., source device, client device, mobile phone, tablet device, lap top, computer, connected or hybrid television (TV), IPTV, Internet TV, Web TV, smart TV, etc.). A device profile for a device is based on one or more parameters including location (e.g., GPS coordinates, IP address, cellular triangulation, etc.) of the device, a social profile for a user of the device, and categories or types of applications installed on the device. Each device includes a respective advertising services software 103, 105, 107 (e.g., software development kit (SDK)) that includes a set of software development tools for advertising services including in-app advertising services. The publishers 182 publish content along with ads. The system 100, devices 102, 104, 106, advertisers 184, and publishers communicate via a network 180 (e.g., Internet, wide area network, etc.). The advertising services provided to the devices may include an in-app video ad that includes a preview (e.g., video trailer) of an application (e.g., mobile application) and in-app ad campaigns for brand and performance advertisers. The processing logic 132 may include a filtering functionality for filtering potential available ad campaigns, an optimizer functionality for determining an optimal ad campaign, and a selector (picker) functionality for selecting an optimal campaign. The filtering functionality may filter ad campaigns based on availability, device characteristics (e.g., device profiles 134), user characteristics (e.g., age, gender, ethnicity, location, etc.).

In one embodiment, the system 100 includes a storage medium 136 to store one or more software programs. Processing logic (e.g., 132) is configured to execute instructions of at least one software program to receive an advertising request from a device upon the device having an ad play event for an initiated software application, determine a bandwidth for a connection between the system and the device, and determine whether at least one ad or ad campaign located on the device or at least one streamed ad or ad campaign will be displayed on the device for the ad play event based on at least one configurable parameter including at least one of the bandwidth for the connection between the device and the ad server, device characteristics, user characteristics, and a service level agreement.

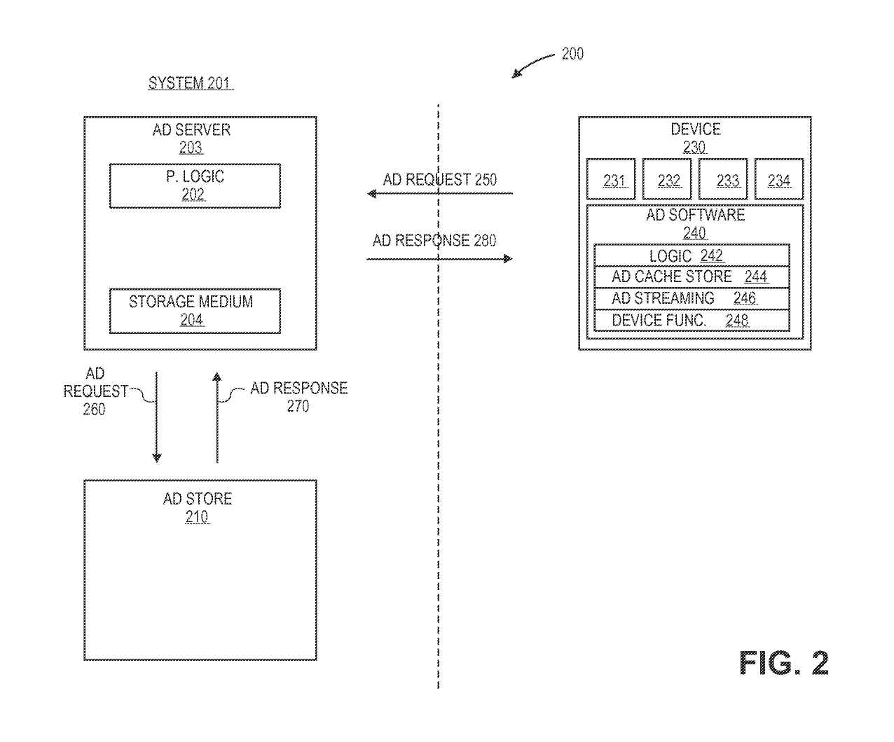

FIG. 2 illustrates a flow diagram of operations for a method of providing advertising services including ad campaigns that are located on a device or streamed to a device in accordance with certain embodiments. The advertising operational flow may be executed by an apparatus or system, which includes processing circuitry or processing logic. The processing logic may include hardware (circuitry, dedicated logic, etc.), software (such as is run on a general purpose computer system or a dedicated machine or a device), or a combination of both. In one embodiment, a system performs the operations of method 200.

A device 230 (e.g., source device, client device, mobile phone, tablet device, lap top, computer, connected or hybrid television (TV), IPTV, Internet TV, Web TV, smart TV, etc) initiates a software application (e.g., at least one of software applications 231-234). For example, a user may select one of the software applications. The advertising services software 240 (e.g., SDK) is also initiated upon the initiation of one of the software applications. The advertising services software 240 may be associated with or embedded with the software applications. The advertising services software 240 may include or be associated with logic 242 (e.g., communication logic for communications such as an ad request), an ad cache store 244 for storing one or more ads or ad campaigns, ad streaming functionality 246 for receiving, optionally storing, and playing streamed ads, and device functionality 248 for determining device and connection capabilities (e.g., type of connection (e.g., 4G LTE, 3G, WiFi, WiMax, etc.), bandwidth of connection, location of device, type of device, display characteristics (e.g., pixel density, color depth), etc.). The initiated software application and associated advertising services software may have an ad play event for displaying or playing an ad on the display of the device. At operation 250, processing logic 202 of an ad server 204 of system 201 receives an ad request from the device 230 upon the device having an ad play event for an initiated software application. The ad request includes different types of information including a publisher of the selected software application, placement information for placement of an ad in-app, user characteristics, and device characteristics. The user and device characteristics can be provided by the publisher or derived from data of the advertising services software 240. The processing logic 202 (or device functionality 248) determines a bandwidth for a connection between the ad server 204 of the system 201 and the device 230. The processing logic 202 (or device functionality 248) determines whether at least one ad or ad campaign (e.g., ad payload) located on the device or at least one streamed ad or ad campaign will be displayed on the device based on at least one configurable parameter including at least one of the bandwidth for the connection between the device and the ad server, device characteristics, user characteristics, a service level agreement of the publisher (e.g., latency), and business rules including location, time of day, availability of new ad campaigns, and availability of higher converting campaigns may also be used in determining whether at least one ad located on the device or at least one streamed ad will be displayed on the device at ad play for a software application. These parameters and business rules can be altered by the system 201 or publisher without affected the advertising services software 240. In particular, these parameters can be altered without affecting a version of the advertising services software 240 such that a user does not need to update a version of the advertising services software even if a configurable parameter or business rule changes. The system 201 is designed to deliver the most relevant and highest converting ads or ad campaign to devices using data about the device behavior and the configurable parameters. A publisher may also initiate determining whether a better ad is available for streaming in comparison to a currently cached ad that is stored on the device 230.

At operation 260, the processing logic 202 sends an ad call or request 260 to an ad store 210. The ad store includes an ad database having ad campaigns and ads. The ad database may a first party ad database, i.e., a database of system 201. The ad store may optionally provide access to third party ad databases. The ad campaigns and ads are capable of being streamed to ad streaming 246 of the device or saved in an ad cache store 240 of the device. At operation 270, the ad server receives an ad response from the ad store 210 in response to the ad call or request. The ad response includes at least one ad or ad campaigns for being streamed to the device 230. The processing logic 202 determines whether to stream at least one ad or ad campaign to the device 230. At operation 280, the processing logic 202 of the ad server 204 sends an ad response to the device 230. The ad response indicates whether at least one ad or ad campaign (e.g., ad payload) located on the device or at least one streamed ad or ad campaign will be displayed on the device during the ad play event. The ad server 204 or device 230 may determine an appropriate time or times to display the at least one cached ad or ad campaign or the at least one streamed ad or ad campaign on the device in accordance with the play ad event.

In a conventional ad network, a user initiates a software application on a mobile device and then the mobile device sends an ad request to the ad network. The ad network responds with an ad response. The mobile device then caches the ad contained with the ad response and plays the ad from cache during a play ad event. However, better, fresher, more relevant ads (i.e., higher converting ads) may be available in comparison to the cached ad of the conventional ad network.

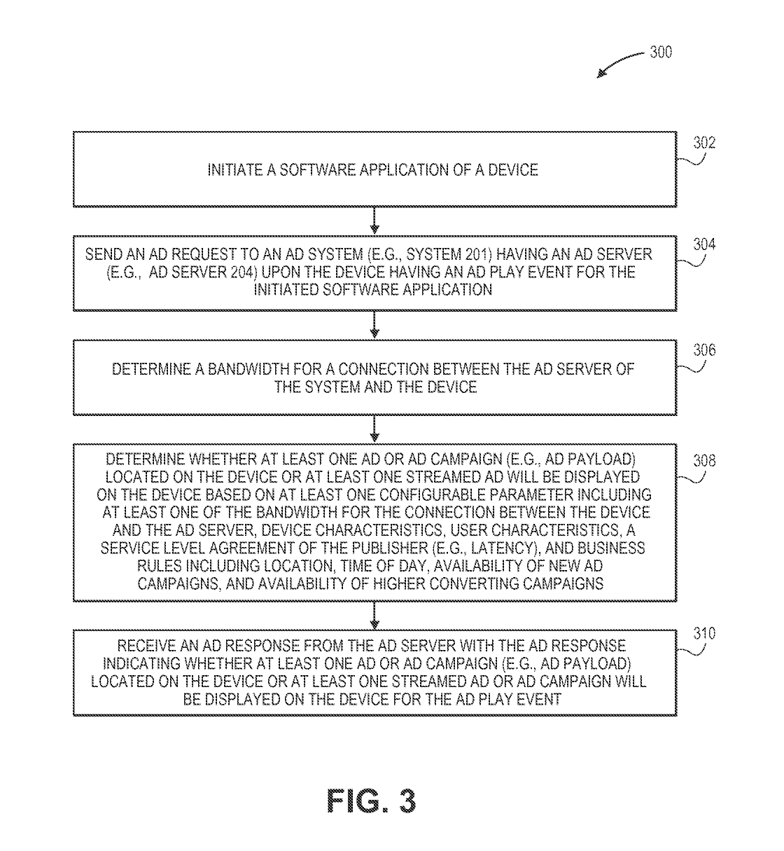

FIG. 3 illustrates a flow diagram of operations for a method of providing advertising services including ad campaigns that are located on a device or streamed to a device in accordance with certain embodiments. The advertising operational flow of method 300 of an ad network may be executed by an apparatus or system or device, which includes processing circuitry or processing logic. The processing logic may include hardware (circuitry, dedicated logic, etc.), software (such as is run on a general purpose computer system or a dedicated machine or a device), or a combination of both. In one embodiment, a device performs the operations of method 300.

At operation 302, a user of a device (e.g., source device, client device, mobile phone, tablet device, lap top, computer, connected or hybrid television (TV), IPTV, Internet TV, Web TV, smart TV, etc) initiates a software application (e.g., at least one of software applications 231-234). For example, a user may select one of the software applications. Advertising services software (e.g., SDK) is also initiated upon the initiation of the one of the software applications. The advertising services software may be associated with or embedded with the software applications. The advertising services software (e.g., advertising services software 240) may include or be associated with logic 242 (e.g., communication logic for communications such as an ad request), an ad cache store 244 for storing one or more ads or ad campaigns, ad streaming functionality 246 for receiving, optionally storing, and playing streamed ads or ad campaigns, and device functionality 248 for determining device and connection characteristics (e.g., type of connection (e.g., 4G LTE, 3G, WiFi, WiMax, etc.), bandwidth of connection, location of device, type of device, display characteristics (e.g., pixel density, color depth), etc.). The initiated software application and associated advertising services software may have an ad play event for displaying or playing an ad or ad campaign on the display of the device. At operation 304, processing logic of the device sends an ad request to an ad network having a system (e.g., system 201) and ad server (e.g., ad server 204) upon the device having an ad play event for an initiated software application. The ad request includes different types of information including a publisher of the selected software application, placement information for placement of an ad in-app, user characteristics, and device characteristics. The user and device characteristics can be provided by the publisher or derived from data of the advertising services software. At operation 306, the processing logic of the device (or device functionality 248) determines a bandwidth for a connection between the ad server of the system and the device. At operation 308, the processing logic of the device (or device functionality 248) determines whether at least one ad or ad campaign (e.g., ad payload) located on the device or at least one streamed ad or ad campaign will be displayed on the device based on at least one configurable parameter including one of the bandwidth for the connection between the device and the ad server, device characteristics, user characteristics, a service level agreement of the publisher (e.g., latency), and business rules including location, time of day, availability of new ad campaigns, and availability of higher converting campaigns may also be used in determining whether at least one ad or ad campaign located on the device or at least one streamed ad or ad campaign will be displayed on the device at ad play for a software application. These parameters can be altered by the system or publisher without affecting the advertising services software. In particular, these parameters can be altered without affecting a version of the advertising services software such that a user does not need to update a version of the advertising services software even if a configurable parameter changes. The system or a publisher may initiate determining whether a better ad or ad campaign is available for streaming in comparison to a currently cached ad that is stored on the device.

At operation 310, the processing logic of the device (or logic 242) receives an ad response from the ad server. The ad response indicates whether at least one ad or ad campaign (e.g., ad payload) located on the device or at least one streamed ad or ad campaign will be displayed on the device for the ad play event.

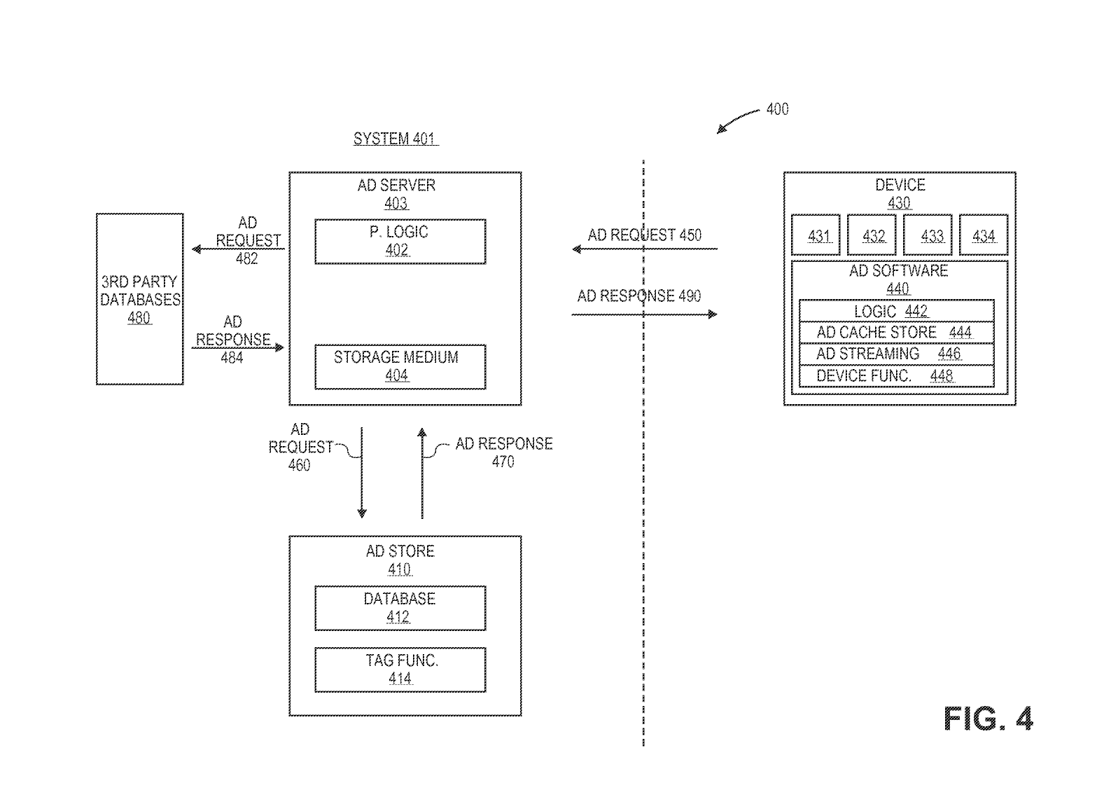

FIG. 4 illustrates a flow diagram of operations for a method of providing advertising services including ad campaigns that are located on a device or streamed to a device from an ad network having access to first and third party ad databases in accordance with certain embodiments. The advertising operational flow may be executed by an apparatus or system, which includes processing circuitry or processing logic. The processing logic may include hardware (circuitry, dedicated logic, etc.), software (such as is run on a general purpose computer system or a dedicated machine or a device), or a combination of both. In one embodiment, a system performs the operations of method 400.

A device 430 (e.g., source device, client device, mobile phone, tablet device, lap top, computer, connected or hybrid television (TV), IPTV, Internet TV, Web TV, smart TV, etc) initiates a software application (e.g., at least one of software applications 431-434). For example, a user may select one of the software applications. The advertising services software 440 is also initiated upon the initiation of one of the software applications. The advertising services software 440 may be associated with or embedded with the software applications. The advertising services software 440 may include or be associated with logic 442 (e.g., communication logic for communications such as an ad request), an ad cache store 444 for storing one or more ads or ad campaigns, ad streaming functionality 446 for receiving, optionally storing, and playing streamed ads or ad campaigns, and device functionality 448 for determining device and connection characteristics (e.g., type of connection (e.g., 4G LTE, 3G, WiFi, WiMax, etc.), bandwidth of connection, location of device, type of device, display characteristics (e.g., pixel density, depth), etc.). The initiated software application may have an ad play event for displaying or playing an ad or ad campaign on the display of the device. At operation 450, processing logic 402 of an ad server 404 of system 401 receives an ad request from the device 430 upon the device having an ad play event for an initiated software application. The ad request includes different types of information including a publisher of the selected software application, placement information for placement of an ad in-app, user characteristics, and device characteristics. The user and device characteristics can be provided by the publisher or derived from data of the advertising services software 440. The processing logic 402 (or device functionality 448) determines a bandwidth for a connection between the ad server 404 of the system 401 and the device 430. The processing logic 402 (or device functionality 448) determines whether at least one ad or ad campaign (e.g., ad payload) located on the device or at least one streamed ad or ad campaign will be displayed on the device based on one or more configurable parameters including the bandwidth for the connection between the device and the ad server, device characteristics, user characteristics, a service level agreement of the publisher (e.g., latency), a cache window, and business rules including location, time of day, availability of new ad campaigns, and availability of higher converting campaigns may also be used in determining whether at least one ad or ad campaign located on the device or a streamed ad will be displayed on the device at ad play for a software application. These parameters can be altered by the system 401 or publisher without affecting the advertising services software 440. A cache window defines a time period during which at least one ad or ad campaign is valid for being displayed on the client device. A cache window has a start time defined by when the at least one ad or ad campaign is served to the device. The ad server or the device can configure the cache window or a third party can define the cache window via a third party ad serving tag. In particular, these parameters can be altered without affecting a version of the advertising services software 440 such that a user does not need to update a version of the SDK even if a configurable parameter changes. The system 401 or a publisher may determine whether a better ad or ad campaign is available for streaming in comparison to a currently cached ad that is stored on the device 430.

At operation 460, the processing logic 402 sends an ad call or request 460 to an ad store 410. The ad store includes an ad database 412 having ad campaigns and ads. The ad database 412 is a first party ad database, i.e., a database of system 401. The ad campaigns and ads are capable of being streamed to ad streaming 446 of the device or saved in an ad cache store 440 of the device. The ad database 410 also includes a tag functionality 414 that generates or stores an ad serving tag for accessing one or more third party ad databases. At operation 470, the ad server 430 receives an ad response from the ad store in response to the ad call or request. The ad response includes a payload with one or more ads or potential ad campaigns for being streamed to the device 430 or an ad serving tag for accessing one or more third party ad databases 480. The processing logic 402 determines whether to stream at least one ad or ad campaign from the ad store 410 to the device 430 or whether to obtain at least one ad or ad campaign from the one or more third party databases 480 using the ad serving tag that is generated or stored by the tag functionality 414. At operation 482, the processing logic 402 saves the ad serving tag, processes the ad serving tag, and sends an ad request to the one or more third party databases 480 that are identified by the ad serving tag. The ad request includes the ad serving tag (or information derived from the ad serving tag) that indicates a third party database for retrieving an ad campaign or ad. At operation 484, the ad server receives an ad response from the one or more third party databases 480. The ad response includes at least one ad or ad campaign for streaming to the device 430. The ad server 403 processes the ad response by formatting and converting the ad response including the ad payload into a standard format for ad responses generated by the ad server. At operation 490, the ad server 403 sends an ad response to the device 430. The ad response indicates whether at least one ad or ad campaign (e.g., ad payload) located on the device or at least one streamed ad or ad campaign from the ad store 410 or the one or more databases 480 will be displayed on the device for the ad play event. Thus, the ad server 403 handles all redirects including ad serving tags for third party databases, processes a format of an ad response including ad responses received from third party databases, and streams this ad response from the third party database or from the database 412 to the device. A web browser or software application of the device does not need to handle any redirects including redirects intended for different third party databases because the ad server handles the redirects and formats the ad response for the device.

In a conventional ad network, a user initiates a software application on a mobile device and then the mobile device sends an ad request to the ad network upon a play ad event occurring. The ad network responds with a call or ad request that is sent to an ad database. The ad database responds with an ad payload or an ad serving tag that is forwarded to the device by the ad network. The device then will need to redirect the ad serving tag to an identified third party database. The third party database responds to the device with an ad or ad campaign. Various types of devices include different types of web browsers. Some types of web browsers may not understand how to redirect the ad serving tag to the appropriate third party database or this redirect operation may be time consuming for the device. Some types of web browsers may also not be compatible with different types of standards (e.g., digital video ad serving template (VAST)) used by different third party ad databases.

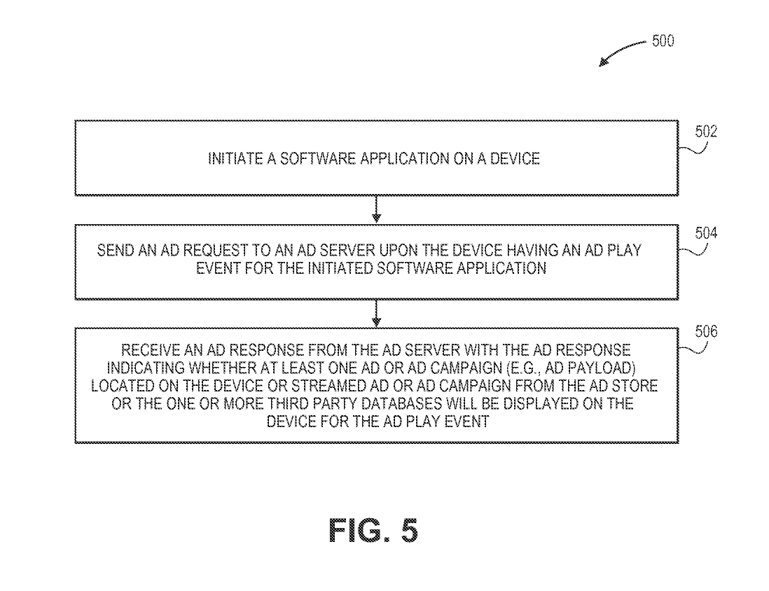

FIG. 5 illustrates a flow diagram of operations for a method of providing advertising services including ad campaigns that are located on a device or streamed from an ad network having access to first and third party ad databases in accordance with certain embodiments. The advertising operational flow of method 500 of an ad network may be executed by an apparatus or system or device, which includes processing circuitry or processing logic. The processing logic may include hardware (circuitry, dedicated logic, etc.), software (such as is run on a general purpose computer system or a dedicated machine or a device), or a combination of both. In one embodiment, a device performs the operations of method 500.

A user of a device (e.g., device 430) initiates a software application (e.g., at least one of software applications 431-434) at operation 502. For example, a user may select one of the software applications. The advertising services software (e.g., SDK) 440 is also initiated upon the initiation of one of the software applications. The SDK 440 may include or be associated with logic 442 (e.g., communication logic for communications such as an ad request), an ad cache store 444 for storing one or more ads or ad campaigns, ad streaming functionality 446 for receiving, optionally storing, and playing streamed ads, and device functionality 448 for determining device and connection characteristics (e.g., type of connection (e.g., 4G LTE, 3G, WiFi, WiMax, etc.), bandwidth of connection, location of device, type of device, display characteristics (e.g., pixel density, depth), etc.). The initiated software application may have an ad play event for displaying or playing an ad or ad campaign on the display of the device. At operation 504, the device sends an ad request to an ad server upon the device having an ad play event for an initiated software application. The ad request includes different types of information including a publisher of the selected software application, placement information for placement of an ad in-app, user characteristics, and device characteristics. The user and device characteristics can be provided by the publisher or derived from data of the advertising services software. The device functionality (or processing logic 402) determines a bandwidth for a connection between the ad server 404 of the system 401 and the device 430. The device functionality 448 (or processing logic 402) determines whether at least one ad or ad campaign (e.g., ad payload) located on the device or at least one streamed ad or ad campaign will be displayed on the device based on one or more configurable parameters including the bandwidth for the connection between the device and the ad server, device characteristics, user characteristics, a service level agreement of the publisher (e.g., latency), a cache window, and business rules including location, time of day, availability of new ad campaigns, and availability of higher converting campaigns. The ad server or the device can configure the cache window or a third party can define the cache window via a third party ad serving tag. These parameters can be altered by the system 401 or publisher without affecting the advertising services software 440 (e.g., SDK). In particular, these parameters can be altered without affecting a version of the advertising services software 440 such that a user does not need to update a version of the advertising services software even if a configurable parameter changes.

Next, operations similar to the operations 460, 470, 482, 484 of FIG. 4 occur. The ad server 403 processes the ad response received from the one or more databases 480 by formatting and converting the ad response including the ad payload into a standard format for ad responses generated by the ad server. At operation 506, the device receives an ad response from the ad server. The ad response indicates whether at least one ad or ad campaign (e.g., ad payload) located on the device or at least one streamed ad or ad campaign from the ad store 410 or the one or more third party databases 480 will be displayed on the device for the ad play event. Thus, the ad server 403 handles all redirects including ad serving tags for third party databases, processes a format of an ad response including ad responses received from third party databases, and streams this ad response from the third party database or from the database 412 to the device. A browser or software application of the device does not need to handle redirects intended for different third party databases because the ad server handles the redirects and formats the ad response for the device.

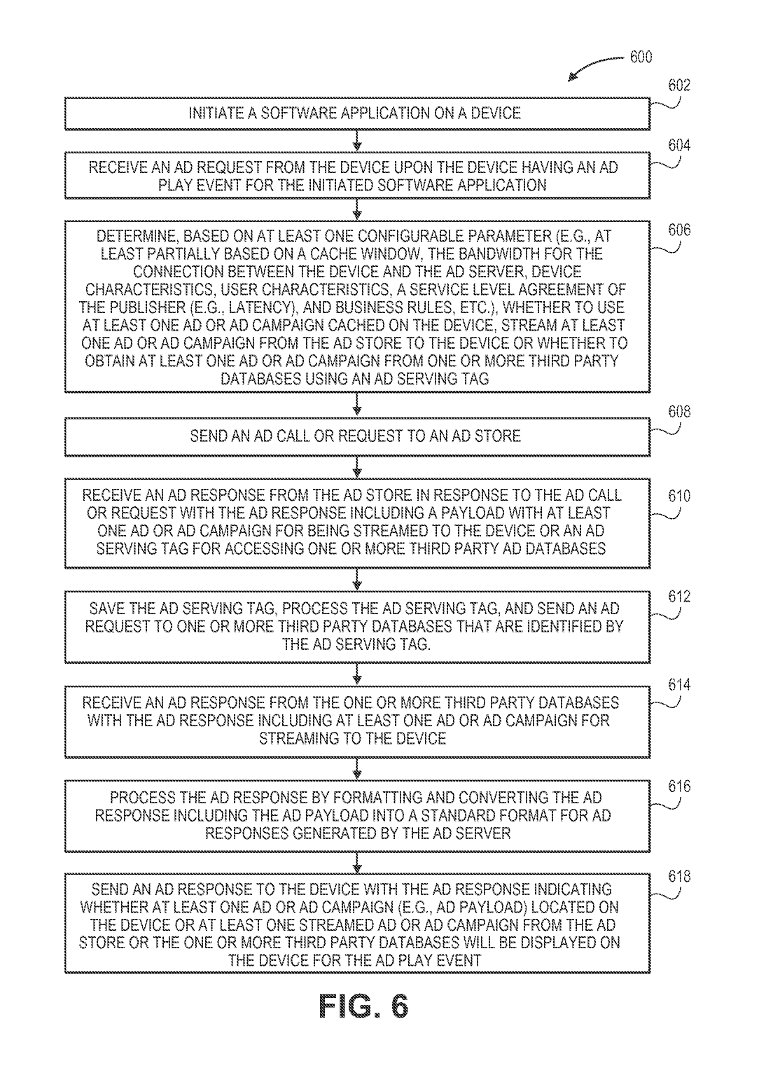

FIG. 6 illustrates a flow diagram of operations for a method of providing advertising services including processing ad serving tags in accordance with certain embodiments. The advertising operational flow may be executed by an apparatus or system, which includes processing circuitry or processing logic. The processing logic may include hardware (circuitry, dedicated logic, etc.), software (such as is run on a general purpose computer system or a dedicated machine or a device), or a combination of both. In one embodiment, a system performs the operations of method 600.

A device initiates a software application at operation 602. For example, a user may select one of the software applications. The advertising services software is also initiated upon the initiation of one of the software applications. The advertising services software may include or be associated with logic (e.g., communication logic for communications such as an ad request), an ad cache store for storing one or more ads or ad campaigns, ad streaming functionality for receiving, optionally storing, and playing streamed ads, and device functionality for determining device and connection characteristics (e.g., type of connection (e.g., 4G LTE, 3G, WiFi, WiMax, etc.), bandwidth of connection, location of device, type of device, display characteristics (e.g., pixel density, depth), etc.). The initiated software application may have an ad play event for displaying or playing an ad on the display of the device. At operation 604, processing logic of an ad server of an ad system receives an ad request from the device upon the device having an ad play event for the initiated software application. The ad request includes different types of information including a publisher of the selected software application, placement information for placement of an ad in-app, user characteristics, and device characteristics. The user and device characteristics can be provided by the publisher or derived from data of the advertising services software. The processing logic of an ad server (or device functionality of a device) determines a bandwidth for a connection between the ad server and the device. At operation 606, the processing logic of the ad server determines, based on at least one configurable parameter (e.g., at least partially based on a cache window, the bandwidth for the connection between the device and the ad server, device characteristics, user characteristics, a service level agreement of the publisher (e.g., latency), and business rules, etc.), whether to use at least one ad campaign or ad cached on the device, stream at least one ad or ad campaign from the ad store to the device or whether to obtain at least one ad or ad campaign from one or more third party databases using an ad serving tag that is generated or stored by the tag functionality of the ad store. The configurable parameters include a cache window, the bandwidth for the connection between the device and the ad server, device characteristics, user characteristics, a service level agreement of the publisher (e.g., latency), and business rules including location, time of day, availability of new ad campaigns, and availability of higher converting campaigns. These parameters can be altered by the system or publisher without affecting the advertising services software.

A cache window defines a time period during which at least one ad or ad campaign is valid for being displayed on the client device. A cache window has a start time defined by when at least one ad or ad campaign is served to the device. The ad server or the device can configure the cache window or a third party can define some or all specifications of the cache window via a third party ad serving tag. In particular, these parameters can be altered without affecting a version of the advertising services software such that a user does not need to update a version of the advertising services software even if a configurable parameter changes. At operation 608, the processing logic of an ad server sends an ad call or request to an ad store. The ad store includes an ad database having ad campaigns and ads. The ad database is a first party ad database, e.g., a database of system 401. The ad campaigns and ads are capable of being streamed to ad streaming functionality of the device or saved in an ad cache store of the device. The ad database also includes a tag functionality that generates or stores an ad serving tag for accessing one or more third party ad databases. At operation 610, the ad server receives an ad response from the ad store in response to the ad call or request. The ad response includes a payload with at least one ad or ad campaigns for being streamed to the device or an ad serving tag for accessing one or more third party ad databases. At operation 612, the processing logic saves the ad serving tag, processes the ad serving tag, and sends an ad request to one or more third party databases that are identified by the ad serving tag. The ad request includes the ad serving tag (or information derived from the ad serving tag) that indicates a third party database for retrieving an ad campaign or ad. At operation 614, the ad server receives an ad response from the one or more third party databases. The ad response includes at least one ad or ad campaign for streaming to the device. At operation 616, the ad server processes the ad response by formatting and converting the ad response including the ad payload into a standard format for ad responses generated by the ad server. At operation 618, the ad server sends an ad response to the device. The ad response indicates whether at least one ad or ad campaign (e.g., ad payload) located on the device or at least one streamed ad or ad campaign from the ad store or the one or more third party databases will be displayed on the device for the ad play event.

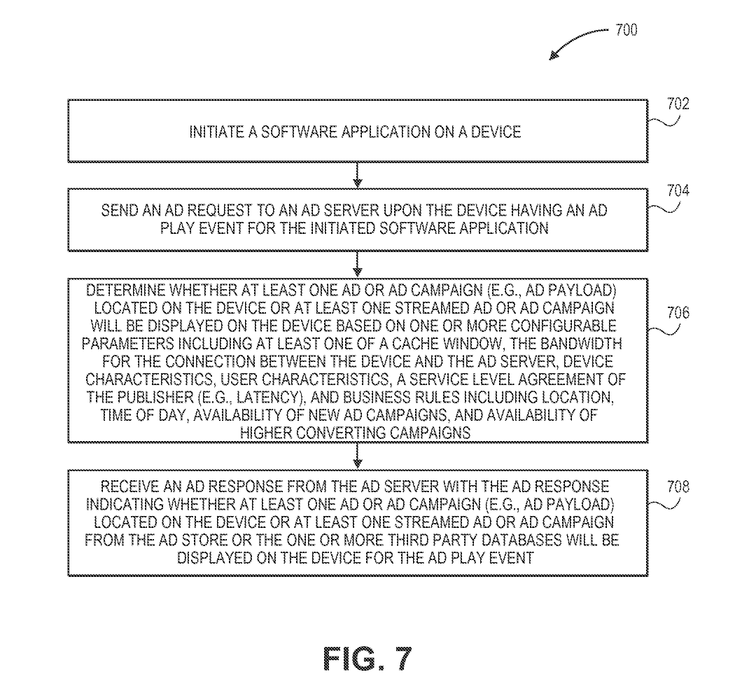

FIG. 7 illustrates a flow diagram of operations for a method of providing advertising services including processing ad serving tags in accordance with certain embodiments. The advertising operational flow of method 700 of an ad network may be executed by an apparatus or system or device, which includes processing circuitry or processing logic. The processing logic may include hardware (circuitry, dedicated logic, etc.), software (such as is run on a general purpose computer system or a dedicated machine or a device), or a combination of both. In one embodiment, a device performs the operations of method 700.

A device initiates a software application at operation 702. For example, a user may select one of the software applications. The advertising services software is also initiated upon the initiation of one of the software applications. The advertising services software may include logic (e.g., communication logic for communications such as an ad request), an ad cache store for storing one or more ads or ad campaigns, ad streaming functionality for receiving, optionally storing, and playing streamed ads, and device functionality for determining device and connection characteristics (e.g., type of connection (e.g., 4G LTE, 3G, WiFi, WiMax, etc.), bandwidth of connection, location of device, type of device, display characteristics (e.g., pixel density, depth), etc.). The initiated software application may have an ad play event for displaying or playing an ad on the display of the device. At operation 704, the device sends an ad request to an ad server of an ad system upon the device having an ad play event for the initiated software application. The ad request includes different types of information including a publisher of the selected software application, placement information for placement of an ad in-app, user characteristics, and device characteristics. The user and device characteristics can be provided by the publisher or derived from data of the advertising services software (e.g., SDK). The device functionality of the device (or processing logic of an ad server) determines a bandwidth for a connection between the ad server and the device. At operation 706, the device functionality (or ad server) determines whether at least one ad or ad campaign (e.g., ad payload) located on the device or at least one streamed ad or ad campaign will be displayed on the device based on one or more configurable parameters including at least one of a cache window, the bandwidth for the connection between the device and the ad server, device characteristics, user characteristics, a service level agreement of the publisher (e.g., latency), and business rules including location, time of day, availability of new ad campaigns, and availability of higher converting campaigns. The determination may be at least partially based on a cache window. These parameters can be altered by the system or publisher without affecting the advertising services software 440. A cache window defines a time period during which at least one ad or ad campaign is valid for being displayed on the client device. A cache window has a start time defined by when the at least one ad or ad campaign is served to the device. The ad server or the device can configure the cache window or a third party can define some or all specifications of the cache window via a third party ad serving tag. In particular, these parameters can be altered without affecting a version of the advertising services software such that a user does not need to update a version of the advertising services software even if a configurable parameter changes. Next, the ad server performs operations similar to operations 606-616 (or 608-616) of method 600. At operation 708, the device receives an ad response from the ad server. The ad response indicates whether at least one ad or ad campaign (e.g., ad payload) located on the device or at least one streamed ad or ad campaign from the ad store or the one or more third party databases will be displayed on the device for the ad play event.

In some embodiments, the operations of the methods disclosed herein can be altered, modified, combined, or deleted. For example, the operation 604 can occur later in the flow of operations of method 600. This determination of operation 604 may not occur until a latency is known for obtaining an ad from the ad store or the one or more third party ad databases. The methods in embodiments of the present invention may be performed with an apparatus or data processing system as described herein. The apparatus or data processing system may be a conventional, general-purpose computer system or special purpose computers, which are designed or programmed to perform only one function, may also be used.

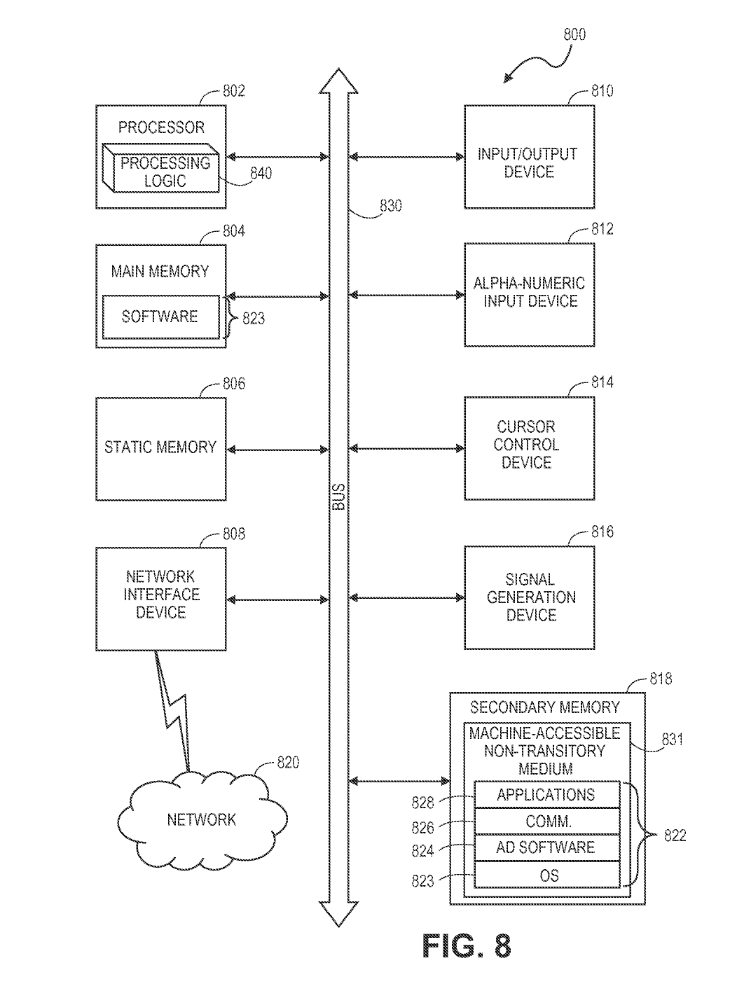

FIG. 8 illustrates a diagrammatic representation of a machine in the exemplary form of a computer system or device 800 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a mobile device, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary device 800 includes a processing device (processor) 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage device 818, which communicate with each other via a bus 830.

Processor 802 represents one or more general-purpose processing devices such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 802 may also be one or more special-purpose processing devices such as an application specific integrated circuit (ASIC), a field programmable gate array (FPGA), a digital signal processor (DSP), network processor, or the like. The processor 802 is configured to execute the processing logic 826 for performing the operations and steps discussed herein.

The device 800 may further include a network interface device 808. The device 800 also may include an input/output device or display (e.g., a liquid crystal display (LCD), a plasma display, a cathode ray tube (CRT), or touch screen for receiving user input and displaying output), an optional alphanumeric input device 812 (e.g., a keyboard), an optional cursor control device 814 (e.g., a mouse), and a signal generation device 816 (e.g., a speaker).

The data storage device 818 may include a machine-accessible non-transitory medium 831 on which is stored one or more sets of instructions (e.g., software 822) embodying any one or more of the methodologies or functions described herein. The software 822 may include an operating system 823, advertising services software 824, communications module 826, and applications 828 (e.g., publisher applications). The software 822 may also reside, completely or at least partially, within the main memory 804 (e.g., software 823) and/or within the processor 802 during execution thereof by the device 800, the main memory 804 and the processor 802 also constituting machine-accessible storage media. The software 822 or 823 may further be transmitted or received over a network 820 via the network interface device 808.

The machine-accessible non-transitory medium 831 may also be used to store data structure sets that define user identifying states and user preferences that define user profiles. Data structure sets and user profiles may also be stored in other sections of device 800, such as static memory 806.

In one embodiment, a machine-accessible non-transitory medium contains executable computer program instructions which when executed by a data processing system cause the system to perform any of the methods as discussed herein.

For example, in one embodiment, a machine-accessible non-transitory medium containing executable computer program instructions which when executed by a data processing system cause said system to perform a method. The method includes receiving, with the system, an advertising request from a device upon the device having an ad play event for an initiated software application, sending an ad call or request to an ad store having ad campaigns and ads, and receiving an ad response from the ad store in response to the ad call or request. The ad response includes a payload with at least one ad for being streamed to the device or an ad serving tag for accessing one or more third party ad databases.

For example, in one embodiment, the method further includes determining whether to stream at least one ad from the ad store to the device or whether to obtain at least one ad from the one or more third party databases using the ad serving tag.

For example, in one embodiment, the method further includes sending an ad request including the ad serving tag to the one or more third party databases.

For example, in one embodiment, the method further includes processing the ad response received from the one or more third party databases by formatting and converting the ad response including the ad payload into a standard format for ad responses generated by the system. The method further includes sending an ad response to the device with the ad response indicating whether at least one ad located on the device, at least one streamed ad from the ad store, or at least one streamed ad from the one or more third party databases will be displayed on the device for the ad play event.

While the machine-accessible non-transitory medium 831 is shown in an exemplary embodiment to be a single medium, the term “machine-accessible non-transitory medium” should be taken to include a single medium or multiple media (e.g., a centralized or distributed database, and/or associated caches and servers) that store the one or more sets of instructions. The term “machine-accessible non-transitory medium” shall also be taken to include any medium that is capable of storing, encoding or carrying a set of instructions for execution by the machine and that cause the machine to perform any one or more of the methodologies of the present invention. The term “machine-accessible non-transitory medium” shall accordingly be taken to include, but not be limited to, solid-state memories, optical and magnetic media, and carrier wave signals.

In one embodiment, a system includes a storage medium to store one or more software programs and processing logic that is configured to execute instructions of at least one software program to receive an advertising request from a device upon the device having an ad play event for an initiated software application, send an ad call or request to an ad store having ad campaigns and ads, and receive an ad response from the ad store in response to the ad call or request. The ad response includes a payload with at least one ad for being streamed to the device or an ad serving tag for accessing one or more third party ad databases.

For example, in one embodiment, the processing logic is further configured to execute instructions of the at least one software program to determine whether to stream at least one ad from the ad store to the device or whether to obtain at least one ad from the one or more third party databases using the ad serving tag.

In one embodiment, the processing logic is configured to execute instructions of the at least one software program to send an ad request including the ad serving tag to the one or more third party databases.

For example, in one embodiment, the processing logic is configured to execute instructions of the at least one software program to process the ad response received from the one or more third party databases by formatting and converting the ad response including the ad payload into a standard format for ad responses generated by the system.

For example, in one embodiment, the processing logic is configured to execute instructions of the at least one software program to send an ad response to the device with the ad response indicating whether at least one ad located on the device, at least one streamed ad from the ad store, or at least one streamed ad from the one or more third party databases will be displayed on the device for the ad play event.

In one embodiment, a method for providing advertising services with a system includes receiving, with the system, an advertising request from a device upon the device having an ad play event for an initiated software application, sending an ad call or request to an ad store having ad campaigns and ads, and receiving an ad response from the ad store in response to the ad call or request. The ad response includes a payload with at least one ad for being streamed to the device or an ad serving tag for accessing one or more third party ad databases.

In one embodiment, the method includes determining whether to stream at least one ad from the ad store to the device or whether to obtain at least one ad from the one or more third party databases using the ad serving tag.

For example, in one embodiment, the method also includes sending an ad request including the ad serving tag to the one or more third party databases.

For example, in one embodiment, the method includes processing the ad response received from the one or more third party databases by formatting and converting the ad response including the ad payload into a standard format for ad responses generated by the system.

For example, in one embodiment, the method includes sending an ad response to the device with the ad response indicating whether at least one ad located on the device, at least one streamed ad from the ad store, or at least one streamed ad from the one or more third party databases will be displayed on the device for the ad play event.

In one embodiment, an apparatus for providing advertising services includes a means for storing one or more software programs and a processing means to execute instructions of at least one software program to receive an advertising request from a device upon the device having an ad play event for an initiated software application, send an ad call or request to an ad store having ad campaigns and ads, and receive an ad response from the ad store in response to the ad call or request. The ad response includes a payload with at least one ad for being streamed to the device or an ad serving tag for accessing one or more third party ad databases.

For example, in one embodiment, the processing means is further configured to execute instructions of the at least one software program to determine whether to stream at least one ad from the ad store to the device or whether to obtain at least one ad from the one or more third party databases using the ad serving tag.

For example, in one embodiment, the processing means is further configured to execute instructions of the at least one software program to send an ad request including the ad serving tag to the one or more third party databases and process the ad response received from the one or more third party databases by formatting and converting the ad response including the ad payload into a standard format for ad responses generated by the system.

In one embodiment, a method includes receiving an advertising request from a device upon the device having an ad play event for an initiated software application, sending an ad call or request to an ad store having ad campaigns and ads, and receiving an ad response from the ad store in response to the ad call or request. The ad response includes a payload with at least one ad for being streamed to the device or an ad serving tag for accessing one or more third party ad databases.

For example, in one embodiment, the ad request includes different types of information including a publisher of the selected software application, placement information for placement of an ad in-app, user characteristics, and device characteristics.

For example, in one embodiment, the device includes advertising services software that is initiated upon the initiation of the software application. The advertising services software includes logic for communications, an ad cache store for storing at least one ads, ad streaming functionality for receiving and playing streamed ads, and device functionality for determining device and connection characteristics.

In one embodiment, a machine-accessible non-transitory medium containing executable computer program instructions which when executed by a device cause said device to perform a method. The method includes receiving an advertising request from a device upon the device having an ad play event for an initiated software application, sending an ad call or request to an ad store having ad campaigns and ads, and receiving an ad response from the ad store in response to the ad call or request. The ad response includes a payload with at least one ad for being streamed to the device or an ad serving tag for accessing one or more third party ad databases.

For example, in one embodiment the ad request includes different types of information including a publisher of the selected software application, placement information for placement of an ad in-app, user characteristics, and device characteristics.

For example, in one embodiment, the device includes advertising services software that is initiated upon the initiation of the software application. The advertising services software includes logic for communications, an ad cache store for storing at least one ads, ad streaming functionality for receiving and playing streamed ads, and device functionality for determining device and connection characteristics.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. An advertising system for reducing delay in streaming video ads to a mobile device, comprising:
an ad store that includes a first party ad database having video ad campaigns and video ads, the ad store includes tag functionality for generated an ad serving tag;
an ad server that includes a storage medium to store one or more software programs and processing logic including dedicated logic of the ad server that is configured to execute instructions of at least one software program to:
receive an advertising request from the mobile device upon the mobile device having an ad play event to display or play a video ad in-app within an initiated mobile software application of a publisher on the mobile device;
send an ad call or request to the ad store that includes the first party ad database having video ad campaigns and video ads;
receive an ad response from the ad store in response to the ad call or request, wherein the ad response includes a payload with at least one video ad for being streamed to the device or an ad serving tag for accessing one or more third party ad databases; and
determine whether to stream at least one video ad from the ad store to the mobile device or whether to obtain at least one video ad from the one or more third party ad databases using the ad serving tag based on availability of new video ad campaigns and availability of video ad campaigns that are more likely to convert in at least one of the ad store and the one or more third party ad databases, wherein the advertising system handles redirects including ad serving tags for third party ad databases such that the mobile software application of the mobile device does not handle any redirects intended for third party ad databases.

2. The advertising system of claim 1, wherein the processing logic of the ad server is configured to execute instructions of at least one software program to save the ad serving tag, process the ad serving tag, and send an ad request to one or more third party databases that are identified by the ad serving tag if at least one video ad is to be obtained from the one or more third party databases using the ad serving tag.

3. The advertising system of claim 2, wherein the processing logic is further configured to execute instructions of at least one software program to:
send an ad request including the ad serving tag to the one or more third party ad databases.

4. The advertising system of claim 3, wherein the processing logic is further configured to execute instructions of at least one software program to:
process the ad response received from the one or more third party ad databases by formatting and converting the ad response including the ad payload into a standard format for ad responses generated by the advertising system.

5. The advertising system of claim 4, wherein the processing logic is further configured to execute instructions of at least one software program to:
send an ad response to the device with the ad response indicating whether at least one video ad located on the device, at least one streamed video ad from the ad store, or at least one streamed video ad from the one or more third party ad databases will be displayed on the device for the ad play event.

6. A machine-accessible non-transitory medium containing executable computer program instructions which when executed by a data processing advertising system having dedicated logic cause said advertising system to perform a method for reducing delay in streaming video ads to a mobile device, the method comprising:
receiving, with the advertising system, an advertising request from the mobile device upon the mobile device having an ad play event to display or play a video ad within an initiated software application of a publisher on the mobile device;
sending an ad call or request to an ad store that includes a first party ad database having video ad campaigns and video ads;
receiving an ad response from the ad store in response to the ad call or request, wherein the ad response includes a payload with at least one video ad for being streamed to the mobile device or an ad serving tag for accessing one or more third party ad databases; and
determining whether to stream at least one video ad from the ad store to the mobile device or whether to obtain at least one video ad from the one or more third party ad databases using the ad serving tag based on availability of new video ad campaigns and availability of video ad campaigns that are more likely to convert in at least one of the ad store and the one or more third party ad databases, wherein the ad store includes tag functionality for generating the ad serving tag, wherein the advertising system handles redirects including ad serving tags for third party ad databases such that the mobile software application of the mobile device does not handle any redirects intended for third party ad databases.

7. The machine-accessible non-transitory medium of claim 6, the method further comprising:
saving the ad serving tag; and
processing the ad serving tag.

8. The machine-accessible non-transitory medium of claim 7, the method further comprising:
sending an ad request including the ad serving tag to the one or more third party ad databases that are identified by the ad serving tag if at least one video ad is to be obtained from the one or more third party databases using the ad serving tag.

9. The machine-accessible non-transitory medium of claim 8, the method further comprising:
processing the ad response received from the one or more third party ad databases by formatting and converting the ad response including the ad payload into a standard format for ad responses generated by the advertising system.

10. The machine-accessible non-transitory medium of claim 9, the method further comprising:
sending an ad response to the mobile device with the ad response indicating whether at least one video ad located on the mobile device, at least one streamed video ad from the ad store, or at least one streamed video ad from the one or more third party ad databases will be displayed on the mobile device for the ad play event.

11. A method for reducing delay in streaming video ads to a mobile device comprising:
initiating a mobile software application and associated advertising services software in response to a user selection of the mobile software application of a publisher on the mobile device;
sending, with communication logic of the mobile device, an ad request to an ad server having access to an ad store that includes a first party ad database having video ad campaigns and video ads upon the mobile device having an ad play event to display or play a video ad for the initiated software application of the publisher on the mobile device; and
receiving, with communication logic of the mobile device, an ad response from the ad server, wherein the ad response indicates whether at least one video ad located on the mobile device, at least one streamed video ad from the ad store, or at least one streamed video ad from one or more third party ad databases will be displayed on the mobile device for the ad play event based on availability of new video ad campaigns and availability of video ad campaigns that are more likely to convert in at least one of the ad store and the one or more third party ad databases, wherein the ad server handles redirects including ad serving tags for accessing the third party ad databases such that the mobile software application of the mobile device does not handle any redirects intended for third party ad databases.

12. The method of claim 11, wherein the ad request includes different types of information including the publisher of the selected software application, placement information for placement of the video ad in-app, user characteristics, and device characteristics.

13. The method of claim 11, wherein the mobile device includes the advertising services software that is initiated upon the initiation of the mobile software application, wherein the advertising services software includes logic for communications, an ad cache store for storing at least one ads, ad streaming functionality for receiving and playing streamed video ads, and device functionality for determining device and connection characteristics.

14. A machine-accessible non-transitory medium containing executable computer program instructions which when executed by a mobile device cause said mobile device to perform a method for reducing delay in streaming video ads to the mobile device, the method comprising:
initiating a mobile software application and associated advertising services software in response to a user selection of the mobile software application of a publisher on the mobile device;
sending, with communication logic of the mobile device, an ad request to an ad server having access to an ad store that includes a first party ad database having video ad campaigns and video ads upon the mobile device having an ad play event to display or play a video ad for the initiated software application; and
receiving, with communication logic of the mobile device, an ad response from the ad server, wherein the ad response indicates whether at least one video ad located on the mobile device, at least one streamed video ad from the ad store, or at least one streamed video ad from one or more third party ad databases will be displayed on the mobile device for the ad play event based on availability of new video ad campaigns and availability of video ad campaigns that are more likely to convert in at least one of the ad store and the one or more third party ad databases, wherein the advertising server handles redirects including ad serving tags for accessing third party ad databases such that the mobile software application of the mobile device does not handle any redirects intended for third party ad databases.

15. The machine-accessible non-transitory medium of claim 14, wherein the ad request includes different types of information including the publisher of the selected software application, placement information for placement of the video ad in-app, user characteristics, and device characteristics.

16. The machine-accessible non-transitory medium of claim 14, wherein the mobile device includes advertising services software that is initiated upon the initiation of the software application, wherein the advertising services software includes logic for communications, an ad cache store for storing at least one video ad, ad streaming functionality for receiving and playing streamed video ads, and device functionality for determining device and connection characteristics.

17. The advertising system of claim 1, wherein the advertising system handles redirects including ad serving tags for third party ad databases, which have a digital video ad serving template format, such that the mobile software application of the mobile device does not handle any redirects intended for third party ad databases.

18. The machine-accessible non-transitory medium of claim 6, wherein the advertising system handles redirects including ad serving tags for third party ad databases, which have a digital video ad serving template format, such that the mobile software application of the mobile device does not handle any redirects intended for third party ad databases.
